(19) United States
(12) Patent Application Publication
(10) Pub. No.: US 2003/0101174 A1
(43) Pub. Date: May 29, 2003

(54) Facilitating the searching for text of computer programs

(75) Inventors: Bradd A. Kadlecik, Wappingers Falls, NY (US); Richard W. Potts, Poughquag, NY (US)

Correspondence Address: Blanche E. Schiller, Esq., Heslin Rothenberg Farley & Mesiti P.C., 5 Columbia Circle, Albany, NY, 12203, US

(73) Assignee: International Business Machines Corporation, Armonk, NY

(21) Appl. No.: 09/996,495

(22) Filed: Nov. 29, 2001

(51) Int. Cl. G06F 7/00

(52) U.S. Cl. 707/5

(57) ABSTRACT

Searching for text of a computer program is facilitated by targeting the search. The targeted search includes selecting one or more items associated with the computer program in which to search for the text. Items not associated with the computer program are not selected. Further, the targeted search includes choosing specific locations associated with the computer program within which the items to be searched are to be located. The items and/or locations are selected based on program specific rules.

### TECHNICAL FIELD

This invention relates, in general, to searching techniques, and in particular, to facilitating the searching for text of computer programs by selectively choosing where to search for the text.

### BACKGROUND OF THE INVENTION

There exists many search tools, like FIND or GREP, that are used to search files for selected text. These search tools often search for the text in an entire directory or an entire directory tree, and thus, the search can be very time-consuming. Further, since numerous files are searched, frequently, a number of extraneous or false finds of the text are generated. This is especially true for text that represent common names.

Thus, previous search techniques tend to be error prone in that they produce false positives. Further, they tend to be time-consuming in terms of CPU time, as well as in terms of user time needed to go through and distinguish the false positives.

Based on the foregoing, a need exists for a searching capability that reduces the chance of obtaining false positives and is less time-consuming.

### SUMMARY OF THE INVENTION

The shortcomings of the prior art are overcome and additional advantages are provided through the provision of a method of facilitating searching for text of computer programs. The method includes, for instance, identifying text of a computer program to be searched; and selecting one or more items associated with the computer program in which to search for the text, wherein items not associated with the computer program are not selected to be searched.

In a further aspect of the present invention, a method of facilitating searching for text of computer programs is provided. The method includes, for instance, selecting one or more items in which to search for text of a computer program, the one or more items being associated with the computer program, wherein items not associated with the computer program are not selected to be searched; identifying one or more locations in which the one or more items to be searched for the text are to be included, the one or more locations being associated with the computer program, wherein locations not associated with the computer program are not identified; and wherein at least one of the selecting and identifying uses one or more rules of a programming language of the computer program.

System and computer program products corresponding to the above-summarized methods are also described and claimed herein.

Advantageously, a searching capability is provided which reduces the chance of obtaining false positives and is less time-consuming. In one example, this is accomplished by designating where to search for particular text and limiting the search to those areas, such that areas that do not meet a given criteria are not searched.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one example of a computing environment incorporating and using a searching capability of one or more aspects of the present invention;

FIG. 2 depicts one embodiment of the logic associated with performing a targeted search, in which areas to search are selectively chosen, in accordance with an aspect of the present invention; and

FIG. 3 depicts one example of a sample program having text that is searched, in accordance with an aspect of the present invention.

### BEST MODE FOR CARRYING OUT THE INVENTION

In accordance with an aspect of the present invention, the searching for text (e.g., a function name, a variable, fields, methods or other text string) of a computer program is facilitated by selecting where the search is to be performed. In one example, the search is targeted at specific items (e.g., files, classes), and in a further aspect, at specific locations for those items (e.g., directories, subdirectories). The specific items and/or locations are associated with the computer program, and items and/or locations not associated with the computer program are not searched. Further, in one example, the items and/or locations are selected using one or more rules specific to the programming language of the computer program.

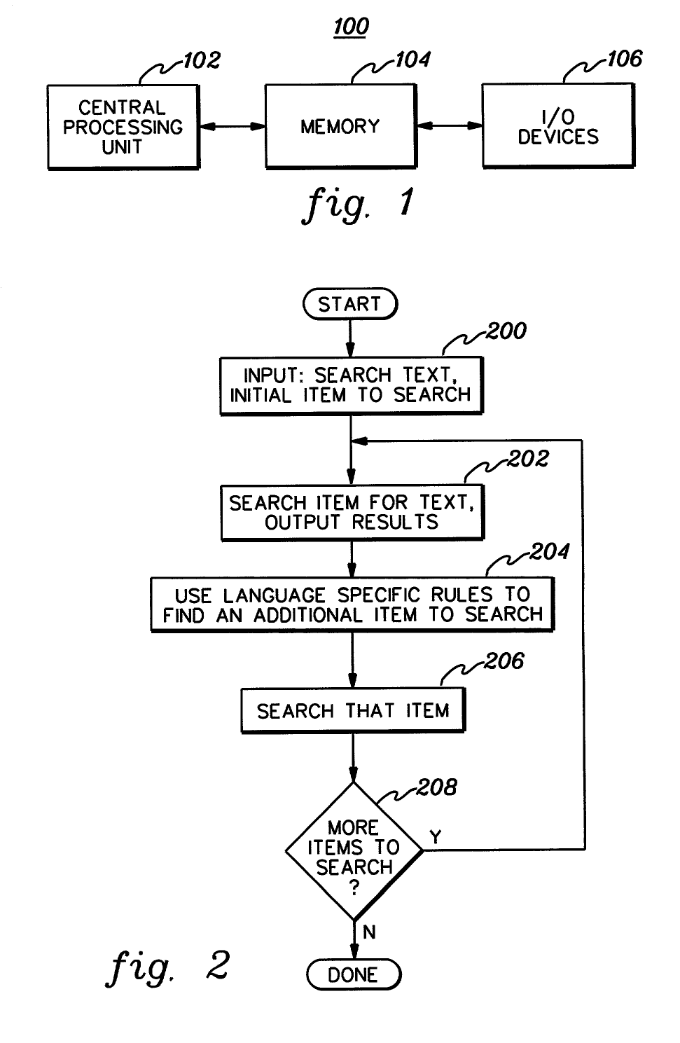

One embodiment of a computing environment incorporating and using one or more aspects of the present invention is described with reference to FIG. 1. Computing environment 100 includes, for instance, one or more central processing units 102, a main storage 104 and one or more input/output devices 106, each of which is known in the art. As one example, computing environment 100 is a single system environment, which includes an RS/6000 computer system running an AIX operating system. RS/6000 and AIX are offered by International Business Machines Corporation, Armonk, N.Y. The invention is not limited to such an environment, however. One or more aspects of the present invention can be incorporated and used with many types of computer systems and computing environments. As an example, in another embodiment, the computing environment may include a plurality of computing units coupled to one another via one or more connections.

Executing within the computing environment are computer programs responsible for performing various tasks. Often, a program references text, such as variables or functions, that are employed by the program, but not defined in the program. At times, like when attempting to update, understand or debug a program, it is desirable to learn more about the referenced, but undefined, text. Thus, a search of the text, which may be located in one or more places, is performed.

In accordance with an aspect of the present invention, a targeted search is performed in order to improve the accuracy and speed of the search. In one example, the search is limited to specific items (e.g., files) that are associated with the program, and in a further example, the search is limited to looking for those specific items in specific locations (e.g., directories) also associated with the computer program. One embodiment of the logic associated with performing such a limited or targeted search is described with reference to FIG. 2.

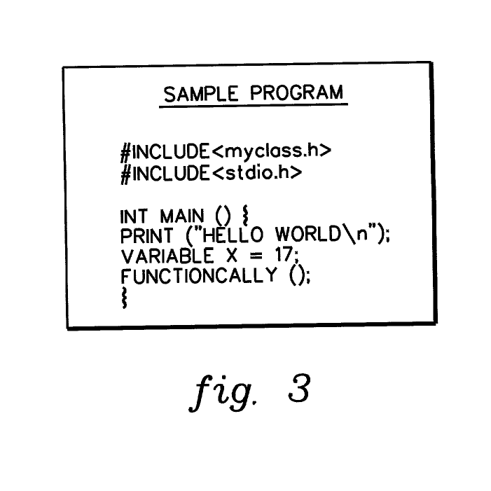

Initially, input to the search logic or tool is text to be searched, as well as an indication of an initial item in which to search the text, STEP 200. As examples, the text may include a function name, a variable, a class instance or any other text string. Further, an item may include, for instance, a name or other indication of a file or other data structure. For example, in the sample C program depicted in FIG. 3, a function, FunctionCallY, is referenced by the program, but it is not defined by the program. Thus, it is desirable to find out further information about FunctionCallY. Since this sample program is in a file referred to as source.c, the search of FunctionCallY commences with source.c (i.e., source.c is the initial item to search for the text, FunctionCallY).

Referring back to FIG. 2, the text is searched in the identified item and the results are output, STEP 202. In one example the results are stored in memory.

Subsequently, language specific rules are used to determine if there are additional items to be searched, STEP 204. In particular, constructs, features or other aspects of the programming language of the program involved in the search are used to select the items to be searched. For example, in the C or C++ programming language, items (e.g., files) may be referenced by an #include statement. Thus, with a C or C++ program, a search for #include statements is performed. Therefore, in the particular example of FIG. 3, myclass.h (and eventually stdio.h) is selected as an item to be searched.

Returning to FIG. 2, the myclass.h file is then searched looking for the identified text, FunctionCallY, STEP 206. Thereafter, a determination is made as to whether there are more items to search, INQUIRY 208. This determination is based, for instance, on the language specific rules. As one particular example, this determination is made by checking whether there are any more #include constructs. If there are no more items to search, then the search is complete. However, if there are more items to search (which in the particular example of FIG. 3, there is the stdio.h file), then processing continues with STEP 202.

Described in detail above is a capability for performing a targeted search to locate text of a computer program, in which the search is limited to specific items associated with the computer program. However, in another example, the search is further limited to looking for the text in specific items in specific locations. Again, the selection of the locations is based on language specific rules. For example in the C or C++ programming language, the locations are designated by environment variables, such as include statements, which are used to specify to the compiler where to search for files pulled in with the #include statement. These statements are used, in accordance with an aspect of the present invention, to further target or limit the search.

As one example, assume the sample program of FIG. 3 is executed on a machine having the following environment variable:

INCLUDE=C:\IBMCPP\INCLUDE;C:\CLASSLIB\INCLUDE;

E:\RICK\INCLUDE;

In that example, the identified text (e.g., FunctionCallY) is only searched, in accordance with an aspect of the present invention, in the selected files (e.g., source.c, myclass.h and stdio.h) in the following chosen directories: C:\IBMCPP\INCLUDE; C:\CLASSLIB\INCLUDE; and E:\RICK\INCLUDE. As one example, the directories are searched in order, and when a file is found in a directory, the search for that file is complete. However, in other examples, each of the chosen directories is searched for that file.

Thus, as described above, the search is limited to one or more items in one or more locations associated with the computer program. The items and/or locations not associated with the program are not searched. The items and/or locations are designated, in one example, by language specific rules.

In the above discussion, the sample C program of FIG. 3 was referenced. This program is described once again below to further illustrate one example of using a targeted search, in accordance with an aspect of the present invention.

Sample Program—source.c

#include<myclass.h>

#include<stdio.h>

int main ( ) {

print (“Hello World\n”);

VariableX=17;

FunctionCallY ( );

}

Sample Header File—myclass.h

Int VariableX=5;

Int FunctionCallY ( )

{

printf (“HI There!”);

}

Environment Variable

INCLUDE=C:\IBMCPP\INCLUDE;C:\CLASSLIB\INCLUDE;E:\RICK\INCLUDE;

Files in Current Directory

Source.c

Myclass.h

Junk.h

Stdio.h

Miscfile.c

Miscfile.h

Filestructure

C:\junk

C:\ibmcpp\include

C:\ibmcpp\include\sys

C:\classlib\include

D:\miscellaneous

E:\rick\include

.

.

.

Illustrated above is a sample program, in which a function, FunctionCallY, is called by this program, but not defined by it. Likewise the variable, VariableX, is set by this program, but not defined by it. To learn more about this function or variable, one or more files are searched. The search begins with the source.c file and continues with one or more header files (e.g., other files pulled in by the #include statement in C and C++ languages) associated with the program.

This example focuses on the FuntionCallY function. The search begins with the source.c module, which is searched, along with any files identified in the #include statements. Further, if those files contain #include statements, then they also would be searched. In this example, it finds FunctionCallY in the myclass.h file. Files not associated with the program (e.g., not the source of the program, or not referenced by the program or files associated with the program) are not searched. Thus, in this example, files junk.h, miscfile.c and miscfile.h, which are in the current directory, but not associated with this particular program, are not searched.

In addition to the above, searches often span more than one directory. Header files, or other source parts, can often reside elsewhere on the user's machine or network. For instance, to search the entire C: drive, the user would use a command like grep -s “FunctionCallY” c:\*.*. This would search every file on the C: drive looking for FunctionCallY. This is time-consuming, and the searching of extra unrelated files can lead to misleading extraneous hits or finds of the key word being searched. However, in accordance with an aspect of the present invention, rules associated with the programming language of the program of the search are used in order to limit the search. For example, in C and C++ environments, an environment variable is used to instruct the compiler where to search for files that are pulled in with the #include statement. Using this information, the search logic searches only relevant locations, such as relevant directories. Thus, in the above example, only the C:\IBMCPP\INCLUDE, C:\CLASSLIB\INCLUDE, and E:\RICK\INCLUDE directories are searched. The other directories such as C:\junk, C:\ibmcpp\include\sys and D:\miscellaneous are not searched.

Another example that demonstrates use of the targeted searching capability of an aspect of the present invention is described below with reference to a Java program.

In Java, there is often difficulty in trying to find all the methods being inherited from a class. There are many directories and subdirectories where classes can be placed, and subdirectories may go quite deep. In Java, classes are found according to the CLASSPATH environment variable. This can specify a directory of classes or either a .jar or zip file which includes a group of classes. So, assume CLASSPATH=C:\jdk\lib\stdstuff.jar;C:\myproj\classes.zip; C:\examples\classes. The stdstuff.jar and classes.zip files can include a myriad of subdirectories and classes. Assume they include the same directory structure, as follows:

com/ibm/

java/

java/applet

java/awt

java/awt/event

java/awt/image

java/awt/peer

java/beans

java/io

java/lang

java/math

java/net

java/rmi

java/rmi/server

java/security

. . .

To use any classes found in either file, an import statement can be used. So, to include classes found in java/math from either stdstuff.jar or classes.zip, the program can have an “import java.math.*;” statement. Further, through the “extends” keyword in java, a class can inherit methods and fields from another class. Constructors and private members are not inherited, however. The inheritance chain of classes can also go quite deep. Take the following example:

java/math/MyClass2.class in classes.zip built from the following MyClass2.java program:

class MyClass2{

int a,b;
MyClass2(int a, int b) {

this.a = a;
this.b = b;

}
public int add2 () {

return a + b;

}

}

C:\examples\classes\MyClass3.class built from the following MyClass3.java program:

imports java.math.*;
class MyClass3 extends MyClass2{

int c;
private int sum;
MyClass3 (int a, int b, int c) {

this.a = a;
this.b = b;
this.c = c;

}
public int add3 () {

sum = add2 () +c;
return sum;

}

}

And now a new program MyClass4.java written as follows:

imports MyClass3;

class MyClass4 extends MyClass3{

. . .

}

To find out what fields and methods are now made available to MyClass4, one would look at MyClass3 and discover that it inherits from MyClass2. Then, one would look at MyClass2 to see if it inherits from another class. This example shows just two chains of inheritance, but it could end up being ten or more, as an example.

To figure out the methods and fields available to MyClass4, a java parser could be incorporated into the editor to recognize the java keywords and syntax. To list the fields (e.g., text) for MyClass4, the extends can be used to find which class (e.g., item) to search. The imports statement can then be used to find which subdirectories (e.g., locations) to search in. Finally, the CLASSPATH environment variable would be used to find the location of the subdirectories. Since the .class files are not .java files, a parser that could interpret class files would be used to be able to determine what classes are declared in the .class file and on a match, to determine what fields and methods are declared as well as whether or not it inherits from another class. If it does inherit, then the same methodology would need to be done again.

Although the above examples reference programs written in C, C++ or Java, the present invention is not limited to such languages. One or more aspects of the present invention are applicable to any programming languages that can benefit from a search of text of a program. Further, the constructs described above are only examples. Other constructs or facilities, such as extends of C++, etc., can be used to defined the search.

Described in detail above is a capability that facilitates searching by limiting or targeting the search to specific items to be searched, which are associated with the computer program of the search. Further, in another aspect, the search is limited by designating locations of where the items are to be located. In one aspect, the items and/or locations to be searched are selected based on language specific rules.

In one embodiment, the logic may be incorporated within a search tool or engine. However, one or more aspects of the present invention can be used by components other than search tools or engines.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A method of facilitating searching for text of computer programs, said method comprising:
identifying text of a computer program to be searched; and
selecting one or more items associated with the computer program in which to search for the text, wherein items not associated with the computer program are not selected to be searched.

2. The method of claim 1, wherein the selecting is based on one or more rules of a programming language of the computer program.

3. The method of claim 1, wherein the one or more items comprise one or more files.

4. The method of claim 1, wherein the one or more items comprise one or more classes.

5. The method of claim 1, wherein the selecting comprises choosing one or more locations associated with the computer program in which the one or more items to be searched are to be included, wherein locations not associated with the computer program are not chosen.

6. The method of claim 5, wherein the one or more locations comprise one or more directories.

7. The method of claim 5, wherein the one or more locations are designated by an environment variable used in compiling the computer program.

8. The method of claim 5, wherein the choosing is based on one or more rules of a programming language of the computer program.

9. The method of claim 1, wherein the text is referenced by the computer program, but not defined within the computer program.

10. A method of facilitating searching for text of computer programs, said method comprising:
selecting one or more items in which to search for text of a computer program, the one or more items being associated with the computer program, wherein items not associated with the computer program are not selected to be searched;
identifying one or more locations in which the one or more items to be searched for the text are to be included, the one or more locations being associated with the computer program, wherein locations not associated with the computer program are not identified; and
wherein at least one of the selecting and identifying uses one or more rules of a programming language of the computer program.

11. A system of facilitating searching for text of computer programs, said system comprising:
means for identifying text of a computer program to be searched; and
means for selecting one or more items associated with the computer program in which to search for the text, wherein items not associated with the computer program are not selected to be searched.

12. The system of claim 11, wherein the selecting is based on one or more rules of a programming language of the computer program.

13. The system of claim 11, wherein the one or more items comprise one or more files.

14. The system of claim 11, wherein the one or more items comprise one or more classes.

15. The system of claim 11, wherein the means for selecting comprises means for choosing one or more locations associated with the computer program in which the one or more items to be searched are to be included, wherein locations not associated with the computer program are not chosen.

16. The system of claim 15, wherein the one or more locations comprise one or more directories.

17. The system of claim 15, wherein the one or more locations are designated by an environment variable used in compiling the computer program.

18. The system of claim 15, wherein the choosing is based on one or more rules of a programming language of the computer program.

19. The system of claim 11, wherein the text is referenced by the computer program, but not defined within the computer program.

20. A system of facilitating searching for text of computer programs, said system comprising:
means for selecting one or more items in which to search for text of a computer program, the one or more items being associated with the computer program, wherein items not associated with the computer program are not selected to be searched;
means for identifying one or more locations in which the one or more items to be searched for the text are to be included, the one or more locations being associated with the computer program, wherein locations not associated with the computer program are not identified; and
wherein at least one of the means for selecting and means for identifying uses one or more rules of a programming language of the computer program.

21. A system of facilitating searching for text of computer programs, said system comprising:
text of a computer program to be searched; and
at least one computing unit to select one or more items associated with the computer program in which to search for the text, wherein items not associated with the computer program are not selected to be searched.

22. A system of facilitating searching for text of computer programs, said system comprising:
at least one computing unit to select one or more items in which to search for text of a computer program, the one or more items being associated with the computer program, wherein items not associated with the computer program are not selected to be searched;
at least one computing unit to identify one or more locations in which the one or more items to be searched for the text are to be included, the one or more locations being associated with the computer program, wherein locations not associated with the computer program are not identified; and
wherein at least one of the selecting and identifying uses one or more rules of a programming language of the computer program.

23. At least one program storage device readable by a machine tangibly embodying at least one program of instructions executable by the machine to perform a method of facilitating searching for text of computer programs, said method comprising:
identifying text of a computer program to be searched; and
selecting one or more items associated with the computer program in which to search for the text, wherein items not associated with the computer program are not selected to be searched.

24. The at least one program storage device of claim 23, wherein the selecting is based on one or more rules of a programming language of the computer program.

25. The at least one program storage device of claim 23, wherein the one or more items comprise one or more files.

26. The at least one program storage device of claim 23, wherein the one or more items comprise one or more classes.

27. The at least one program storage device of claim 23, wherein the selecting comprises choosing one or more locations associated with the computer program in which the one or more items to be searched are to be included, wherein locations not associated with the computer program are not chosen.

28. The at least one program storage device of claim 27, wherein the one or more locations comprise one or more directories.

29. The at least one program storage device of claim 27, wherein the one or more locations are designated by an environment variable used in compiling the computer program.

30. The at least one program storage device of claim 27, wherein the choosing is based on one or more rules of a programming language of the computer program.

31. The at least one program storage device of claim 23, wherein the text is referenced by the computer program, but not defined within the computer program.

32. At least one program storage device readable by a machine tangibly embodying at least one program of instructions executable by the machine to perform a method of facilitating searching for text of computer programs, said method comprising:
selecting one or more items in which to search for text of a computer program, the one or more items being associated with the computer program, wherein items not associated with the computer program are not selected to be searched;
identifying one or more locations in which the one or more items to be searched for the text are to be included, the one or more locations being associated with the computer program, wherein locations not associated with the computer program are not identified; and
wherein at least one of the selecting and identifying uses one or more rules of a programming language of the computer program.
